(19) United States
(12) Patent Application Publication
(10) Pub. No.: US 2026/0199715 A1
(43) Pub. Date: Jul. 16, 2026

(54) Fall Arrest Device

(71) Applicant: Buckingham Manufacturing Company, Inc., Binghamton, NY (US)

(72) Inventors: Timothy Batty, Binghamton, NY (US); Douglas Metcalfe, Arlington, WA (US); Mark Garofano, Camillus, NY (US)

(73) Assignee: Buckingham Manufacturing Company, Inc., Binghamton, NY (US)

(21) Appl. No.: 19/129,951

(22) PCT Filed: Nov. 17, 2023
(86) PCT No.: PCT/IB2023/061659

§ 371 Date: May 14, 2025

Related U.S. Application Data
(60) Provisional application No. 63/384,165, filed on Nov. 17, 2022.

(51) Int. Cl. A62B 1/14; A62B 35/00; F16D 63/00

(52) U.S. Cl. CPC A62B 1/14; A62B 35/0081; F16D 63/008

(57) ABSTRACT

A fall arrest device for preventing a free fall comprising a device configured to accept a line having a toothed stopping mechanism held in a locked position and a tracking wheel assembly configured to detect a free fall and dislodge the stopping mechanism from the locked position causing the stopping mechanism to pinch the line into the case to stop the free fall.

### CROSS-REFERENCE TO RELATED APPLICATIONS

This invention claims priority to U.S. Provisional Application No. 63/384,165 filed on Nov. 17, 2022.

### BACKGROUND OF THE INVENTION

### 1. Field of the Invention

The present disclosure relates generally to safety equipment. More specifically, the present disclosure relates to fall arrest devices.

### 2. Description of the Related Art

Fall arrest devices are commonly used by climbers for safety. When used properly, fall arrest devices work well to prevent a dangerous free fall. For example, if the climber falls off the climbing apparatus or surface, the fall arrest device will prevent the climber from falling to the ground. Conventional devices typically have a tracking method and a stopping method that are accomplished by one mechanism. This can limit conventional devices to only being able to track in one direction along a line. Additionally, conventional devices typically need to be loaded on to a line at the end of the line. This can be time-consuming for the user.

Description of the Related Art Section Disclaimer: To the extent that specific patents/publications/products are discussed above in this Description of the Related Art Section or elsewhere in this disclosure, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety (ies).

### BRIEF SUMMARY OF THE INVENTION

It is therefore a principal object and advantage of the fall arrest device to provide climbers with a bi-directional safety device that has a separate tracking and stopping feature. In one example, the device can be attached to a line and as a worker moves along the line, the tracking wheel rotates such that the teeth run along the line in whatever direction the device is going along the line. This allows for the device to stop along the line, no matter which direction the device is attached on the line or which direction the line is positioned within the device (i.e., the device is bidirectional). If the worker falls, the tracking wheel spins faster and can detect the fall. Once the wheel is rotating at above a specific rate, the stopping mechanism will pinch the line in, preventing the worker from free falling.

It is another object and advantage of the present fall arrest device to provide a device that can be loaded on a line at any point along the line. The ability to load the device in the middle of the line saves the time and hassle of finding the end of the line. Other objects and advantages of the present fall arrest device will in part be obvious and in part appear hereinafter.

It should be understood that the term “line” shall include but not be limited to ropes, cables, webbing, wire, cords, and the like.

### BRIEF DESCRIPTION OF THE SEVERAL VIEWS OF THE DRAWINGS

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIG. 1 is a perspective view of a fall arrest device according to one embodiment.

FIG. 2 is an exploded view of a fall arrest device according to one embodiment.

FIG. 3 is a perspective view of a fall arrest device according to one embodiment on a line.

FIG. 4 is an exploded view of a fall arrest device according to one embodiment.

FIG. 5A is a top view of a tracking wheel according to one embodiment.

FIG. 5B is a bottom view of a tracking wheel according to one embodiment.

FIG. 6A is a perspective view of a tracking wheel assembly according to one embodiment.

FIG. 6B an exploded view of a tracking wheel assembly according to one embodiment.

FIG. 6C is an exploded view of a tracking wheel assembly according to one embodiment.

FIG. 7A is a perspective view of tracking wheel interior assembly according to one embodiment.

FIG. 7B is a perspective partial phantom view of a tracking wheel assembly according to one embodiment.

FIG. 7C is a perspective view of tracking wheel interior assembly according to one embodiment.

FIG. 8A is a perspective view of a plate according to one embodiment.

FIG. 8B is a perspective view of plates according to one embodiment.

FIG. 9 is a perspective view of a rocker cam assembly and tracking wheel assembly according to one embodiment.

FIG. 10 is an exploded view of a rocker cam assembly according to one embodiment.

FIG. 11A is a top view of a rocker cam assembly according to one embodiment.

FIG. 11B is a perspective view of a rocker cam assembly according to one embodiment.

FIG. 12A is a side view of rocker cam assembly and tracking wheel assembly according to one embodiment.

FIG. 12B is a cross section view of rocker cam assembly and tracking wheel assembly according to one embodiment.

FIG. 12C is a cross section of the device with the rocker cam assembly in a locked position according to one embodiment.

FIG. 12D is a cross section view of the device with the rocker cam assembly in a striking position according to one embodiment.

FIG. 12E is a cross section view of the device with the rocker cam assembly in an engaged position according to one embodiment.

FIG. 12F is a cross section view of the device in use on a line in a first direction according to one embodiment.

FIG. 12G is a cross section view of the device in use on a line in a second direction according to one embodiment.

FIG. 12H is a front view of the device in use on a line in an engaged position according to one embodiment.

FIG. 13A is a side view of a fall arrest device according to one embodiment.

FIG. 13B is a perspective view of a fall arrest device according to one embodiment.

FIG. 14A is a front view of a case according to one embodiment.

FIG. 14B is a perspective view of a case according to one embodiment.

FIG. 15A is a perspective view of an inner case according to one embodiment.

FIG. 15B is a perspective view of a case according to one embodiment.

FIG. 16A is a front view of an inner case according to one embodiment.

FIG. 16B is a front view of an outer case according to one embodiment.

FIG. 17A is a cross section view of a fall arrest device according to one embodiment.

FIG. 17B is a perspective view of a fall arrest device according to one embodiment.

FIG. 18A is a perspective view of a fall arrest device according to one embodiment.

FIG. 18B is a perspective view of a fall arrest device according to one embodiment.

FIG. 19 is a perspective view of a fall arrest device according to one embodiment.

FIG. 20 is a bottom view of a fall arrest device according to one embodiment.

FIG. 21 is an exploded view of a fall arrest device according to one embodiment.

FIG. 22 is a perspective view of a rocker cam assembly and tracking wheel assembly according to one embodiment.

FIG. 23 is an exploded view of a rocker cam assembly and tracking wheel assembly according to one embodiment.

FIG. 24 is a perspective view of a tracking wheel assembly according to one embodiment.

FIG. 25 is an exploded view of a tracking wheel assembly according to one embodiment.

FIG. 26 is a perspective view of a fall arrest device according to one embodiment.

FIG. 27 is a perspective view of a fall arrest device according to one embodiment.

FIG. 28 is a perspective view of a fall arrest device according to one embodiment.

FIG. 29 is a perspective view of a fall arrest device according to one embodiment.

FIG. 30A is a perspective view of a rocker cam assembly with blunted teeth according to an alternative embodiment.

FIG. 30B is a side view of a rocker cam assembly with blunted teeth according to an alternative embodiment.

FIG. 31 is a perspective view of a tracking wheel assembly with blunted teeth according to an alternative embodiment.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

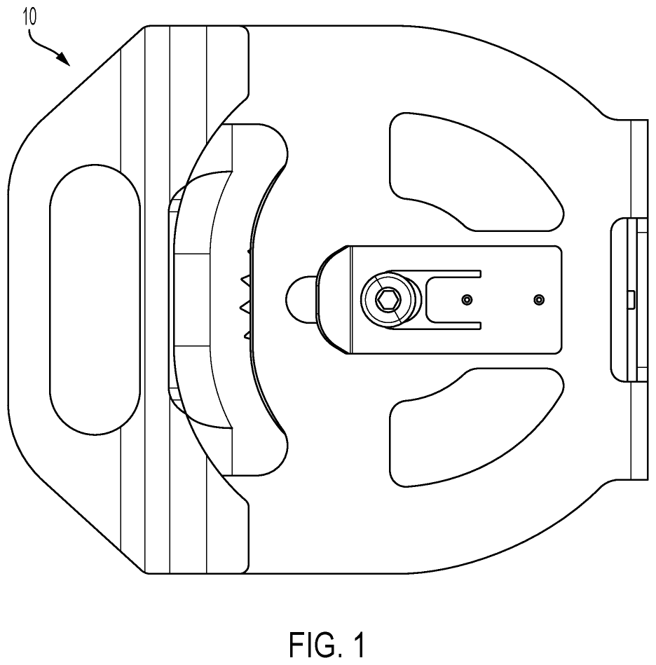

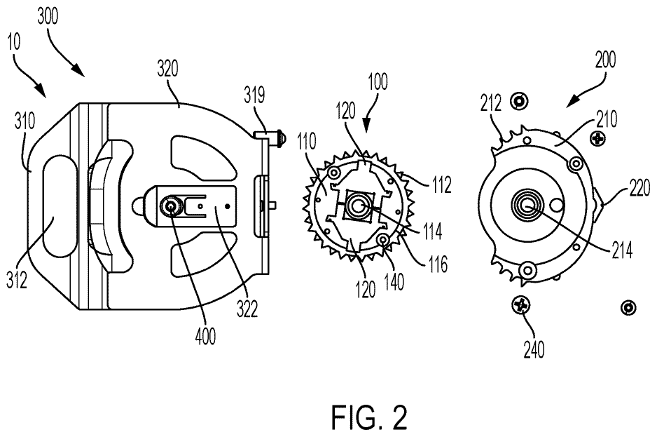

Referring to the figures, wherein like numerals refer to like parts throughout, there is seen in FIG. 1, a fall arrest device according to one embodiment, referred to generally as reference numeral 10. The fall arrest device 10 can be used by a climber when climbing a ladder or other structure and will assist in preventing the climber from free falling to the ground. As shown in FIG. 2, in one example, the fall arrest device 10 is generally comprised of a tracking wheel assembly 100, a rocker cam assembly or stopping mechanism 200, and case 300. In an alternative example, fall arrest device 10 is comprised only of a tracking wheel assembly 100 and a rocker cam assembly 200. In one preferred embodiment, the relative dimensions of the fall arrest device 10 can be 4.44 inches long, 3.80 inches high, and 1.59 inches wide.

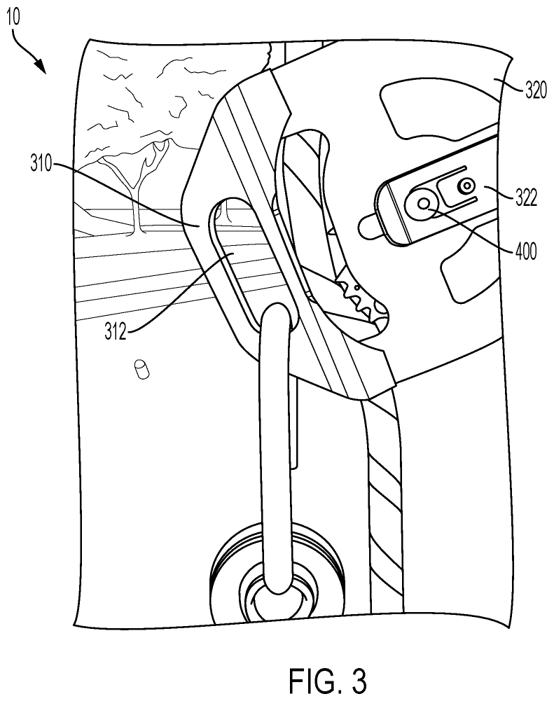

Referring now to FIG. 3, the fall arrest device 10 can be placed on a line and tethered to a climber/user. As the climber moves along the line, the tracking wheel assembly 100 is engaged with the line and rotates at a rate of rotation determined by the speed at which the climber and the fall arrest device 10 moves along the line. In the event that the climber falls or the device 10 is moving along the line at a speed beyond the specific dislodging speed of the device, a dislodging mechanism will dislodge the rocker cam assembly 200. The rocker cam assembly 200 will then engage with the line that is secured to the top of the ladder or other structure. This will arrest the climber's fall and suspend him or her from the ladder or other structure until he or she can recover or be rescued by another person.

The climber can place a line inside of the case 300 such that the tracking wheel assembly 100 is engaged with the line. The tracking wheel assembly 100 rotates within the rocker cam assembly 200 as the fall arrest device 10 moves along the line. The tracking wheel assembly 100 can rotate bidirectionally. When in use, the tracking wheel assembly 100 can rotate with the device's 10 movement up or down the line depending on if the user is ascending or descending. In one example, if the tracking wheel assembly 100 rotates too fast, the tracking wheel assembly 100 will knock the rocker cam assembly 200 out of place and the rocker cam assembly 200 will dig into the line and press the line against case 300 causing the fall arrest device 10 to stop along the line.

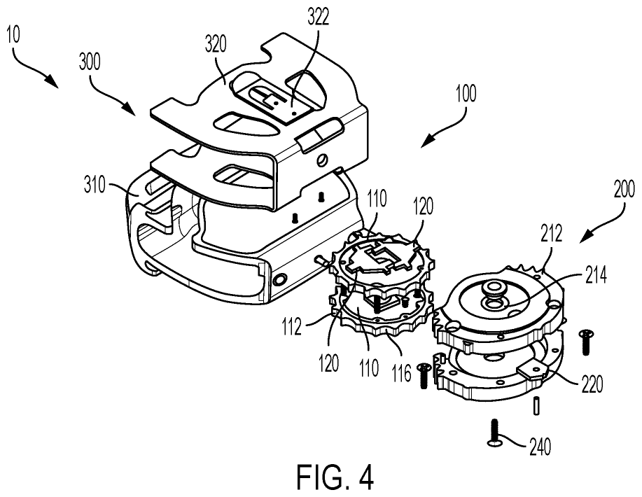

FIG. 4 shows an exploded view of one embodiment of the fall arrest device 10. In this embodiment, the tracking wheel assembly 100 can sit inside of the rocker cam assembly 200 and both assemblies can sit inside the case 300. In one embodiment, the tracking wheel assembly 100 and rocker cam assembly 200 rotate/pivot on a shaft 400. The shaft 400 (not shown) can be placed through aligning openings on the tracking wheel assembly 100, rocker cam assembly 200, and case 300. In one preferred embodiment, the relative dimensions of the rocker cam assembly 200 can be 2.90 inches long, 2.18 inches tall, and 0.77 inches wide.

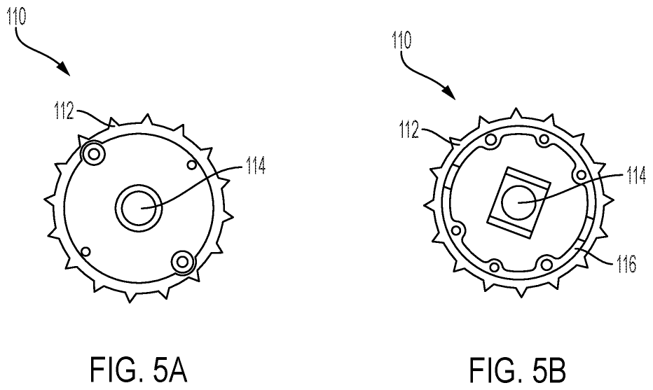

The tracking wheel assembly 100 in one example is generally comprised of a tracking wheel(s) 110 and a dislodging mechanism. An example of the tracking wheel(s) 110 can be seen in FIGS. 5A and 5B. The tracking wheel 110 can comprise teeth 112, opening 114, and edge 116. In one embodiment there are two tracking wheels 110 that fit together while in an alternative embodiment there is only one tracking wheel 110. In one example, tracking wheels 110 have a first surface and a second surface, the second surface of each component can be attached to the other tracking wheel 110. One or both surfaces of the tracking wheel 110 can have a raised edge 116 that can run along the surface. The tracking wheel 110 can also form a groove on the outside diameter. In one example, the groove is formed by the space between two wheels 110. In one preferred embodiment, the relative dimensions of the tracking wheel assembly can be 2.0 inches tall and 0.48 inches wide.

Opening 114 in the center for the tracking wheel 110 allows for the shaft 400 to pass through. In one example, the tracking wheel 110 has a base around the opening 114 to hold the plates 120. In one embodiment, there is a cylinder 150 that can fit within the opening 114.

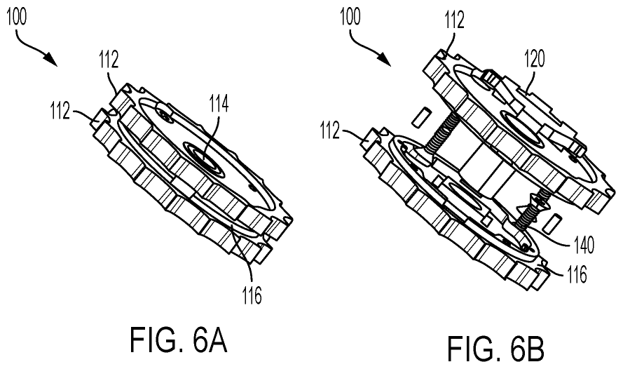

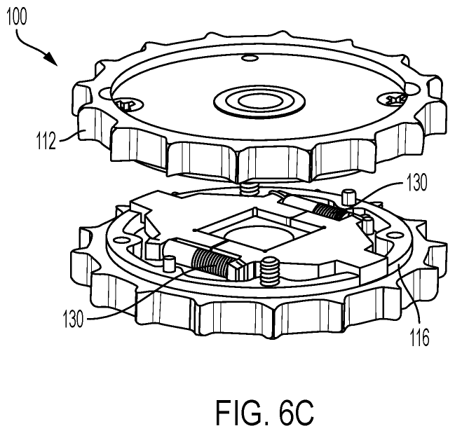

FIGS. 6A-6C depict an example where the tracking wheels 110 fit together to encase the plates 120 and spring 130, and fasteners 140 can hold the two tracking wheels 110 together. In the example shown, there are four fasteners 140, however there can be any number of fasteners. Fasteners 140 can be any suitable fastener such as but not limited to screws, magnets, pins, or glue. There can be openings for the fasteners 140 in the tracking wheel 110. In one example, the openings are symmetrically opposed to one another.

The teeth 112 around the outside of the tracking wheel 110 can engage the line, and the movement of the device 10 either up or down the line will cause the tracking wheel assembly 100 to rotate. The tracking wheel assembly 100 can rotate on shaft 400 in either direction depending on the movement of the device 10 along the line. In an example with two tracking wheels 110, the teeth 112 can be spaced apart or aligned when the two wheels 110 are connected. In one example, the teeth 112 are angled. There can be any number of teeth 112 and they can be any size.

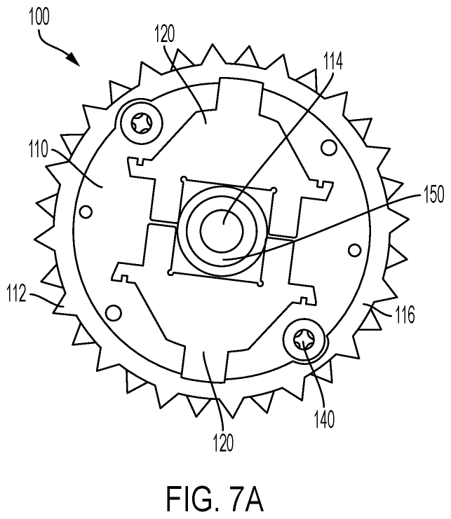

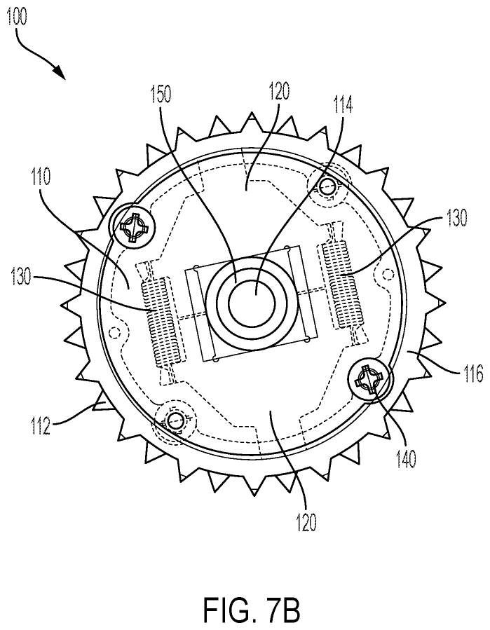

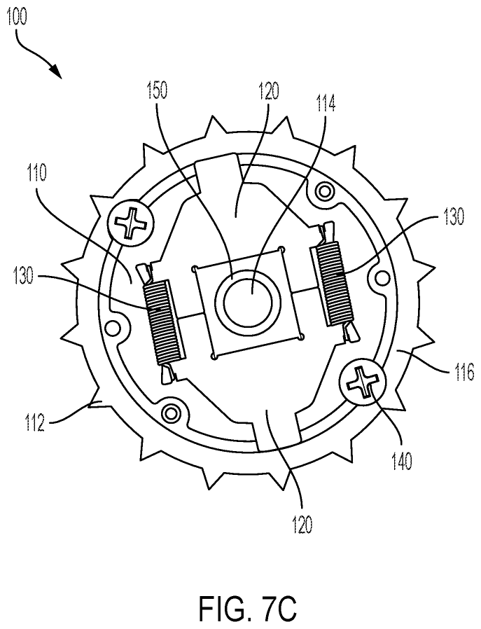

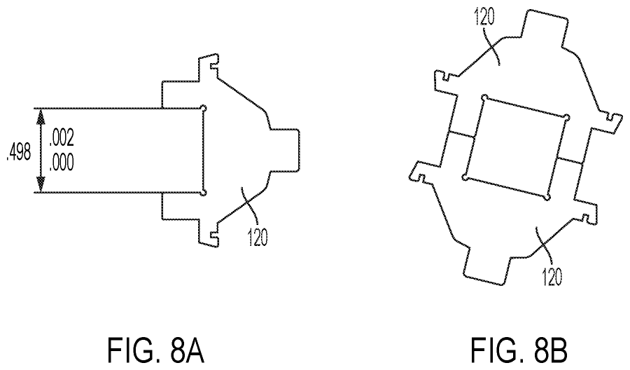

Referring now to FIGS. 7A-7C, there is shown the tracking wheel interior assembly which can comprise the dislodging mechanism. In this example, the dislodging mechanism is plates 120 and springs 130. FIGS. 8A and 8B show an example of plate(s) 120. Plates 120 can be aluminum laser cut sheet metal components or other suitable material. In one preferred embodiment, plates 120 can be made of aluminum due to its relative strength and light weight, although other materials may be used, and the relative dimensions can be 1.14 inches wide, 0.83 inches tall, and 0.09 inches thick. In one embodiment, there are two plates 120 that are attached together with springs 130. There can be one spring 130 or multiple. In another example, the spring 130 can also have one end attached to the tracking wheel 110 and one end attached to plate 120. Springs 130 can have a rating with quantifiable spring tension. In a preferred embodiment, two half-pound force springs can be used.

Plate(s) 120 can have a first position and a second position. In one example, the plate(s) 120 when in the first position is within the tracking wheel assembly and when in the second position at least a portion of the plate(s) 120 is outside of the interior tracking wheel assembly. For example, a portion of the plates can pop out of an opening in edge 116 into the groove formed by the tracking wheels 110. The plate(s) 120 can be shaped and dimensioned such that only a portion can fit out of the opening. The plate(s) can also be on the top or bottom of the tracking wheel 110. In the example where there is only one tracking wheel 110, the first position and the second position refer to being within the groove or outside of the edge 116.

The first position and second position of the plates 120 can be directly related to the tension in the spring 130. For example, spring 130 can have a neutral position and an extended position that allows the plate(s) 120 to separate and/or extend out of the openings in the edge 116. In one example, if the spring 130 is in a neutral position, the plate(s) 120 is held in the first position and sits entirely within the tracking wheel interior assembly and/or within edge 116. If the spring 130 is in an extended position, the plate(s) 120 can be in a second position and pop out of the tracking wheel interior assembly and a portion of the plate 120 can extend past the edge 116.

In this example, where the dislodging mechanism is plates 120 and spring 130, as the tracking wheel 110 moves along the line, the rotation causes the springs 130 to be stretched into the extended position, allowing the plates 120 to move to the second position. The teeth 112 tracking along the line drive the rotation of the tracking wheel 100 and the speed at which the device 10 is moving along the line determines the rate of rotation. Once the tracking wheel assembly 100 reaches a specific rate of rotation/the device 10 is moving along the line at or above the dislodging speed of the device 10, the springs 130 are stretched into the extended position, causing the plates 120 to pop out of the tracking wheel interior assembly and dislodge the rocker cam assembly 200 from its locked position. In one example, this occurs when the device 10 moves along the line at a rate of 7 ft/sec or when the tracking wheel spins at 1000 rpm. The dislodging speed however can be any suitable speed to detect a free fall and can be changed based on the size of the device and the dislodging mechanism used. The dislodging speed is high enough that it will not prevent a worker from climbing the line quickly or going down quickly but low enough to detect a free fall before the user falls too far. The dislodging speed of the device 10 can be calculated using a preferred fall rate of the device 10 and diameter of the device 10, which in this example is 1000 rpm (as should be understood and appreciated by a person of ordinary skill in the art after review of this disclosure).

The gravitational acceleration associated with the dislodging speed may vary depending on the size and weight of the climber, but the device 10 is capable of arresting the fall of climbers of different sizes and weights due to the design of the device 10 with respect to the force of friction on the line and the stopping mechanism used as described herein (as should be understood and appreciated by a person of ordinary skill in the art after review of this disclosure).

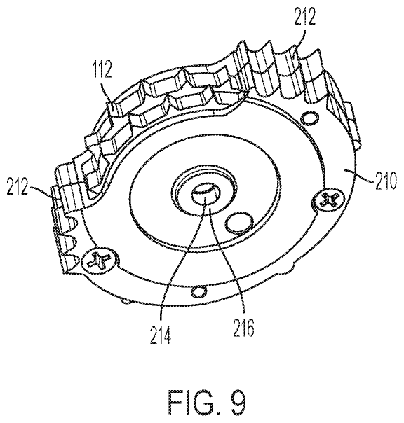

Referring now to FIG. 9, rocker cam assembly 200 in one example is generally comprised of a rocker cam component 210 and a trip mechanism. The rocker cam assembly 200 has a locked position and an engaged position. When in the locked position, the trip mechanism holds the rocker cam assembly 200 in place and the fall arrest device 10 can move freely along the line in either direction. The trip mechanism can be any mechanism or component which holds the rocker cam assembly 200 in the locked position and releases the rocker cam assembly 200 when the device 10 reaches the dislodging speed. When in the engaged position, the rocker cam assembly 200 engages the line and prevents the user from falling by preventing the device 10 from moving along the line any further. Rocker cam assembly 200 can pivot or slide into a variety of different positions and can rotate both clockwise and counterclockwise.

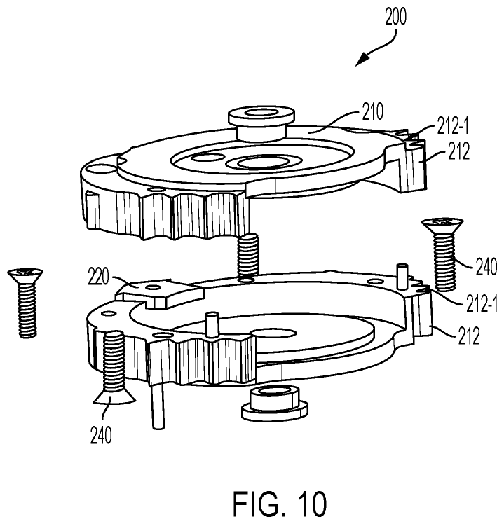

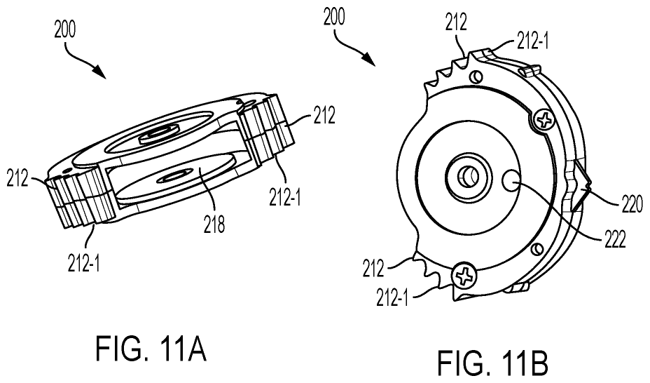

FIGS. 10, 11A, and 11B depict examples of two rocker cam components 210 that can fit together. In an embodiment with two rocker cam components 210, each rocker cam component 210 can have a first surface and a second surface, and the second surface of each component 210 can be attached to the other. The rocker cam assembly 200 can pivot and/or rotate on shaft 400. Rocker cam components 210 can form an opening 214 for shaft 400. In one example, there is a cylinder(s) 216 that fits inside opening 214.

In an example with two rocker cam components 210, fasteners 240 can hold the two rocker cam components 210 together. In the example shown, there are four fasteners 240 and two pins, however there can be any number of fasteners 240. Fasteners 240 can be any suitable fastener such as but not limited to screws, magnets, pins, or glue. There can be openings for the fasteners 240 in the rocker cam components 210. In one example, the openings are symmetrically opposed to one another.

In an example with two rocker cam components 210, when the components 210 are attached to one another, they can form opening 218 where the tracking wheel assembly teeth 112 are exposed to engage the line. Extending from the outer edge of the rocker cam component 210 are teeth 212. Teeth 212 can be angled, and each tooth can be a different size, or they can be uniform. In one embodiment, teeth 212 have line engaging ends that are sharp and come to a point 212-1 to push into and engage with a line made of a softer material, such as rope or webbing. In the example shown, the teeth 212 closest to the opening 218 are smallest and the teeth 212 furthest away are the largest. When the rocker cam assembly 200 digs into the line, the teeth closest to the opening 218 will dig in first.

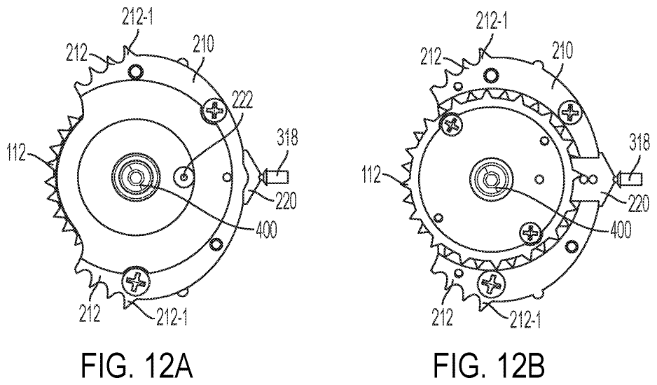

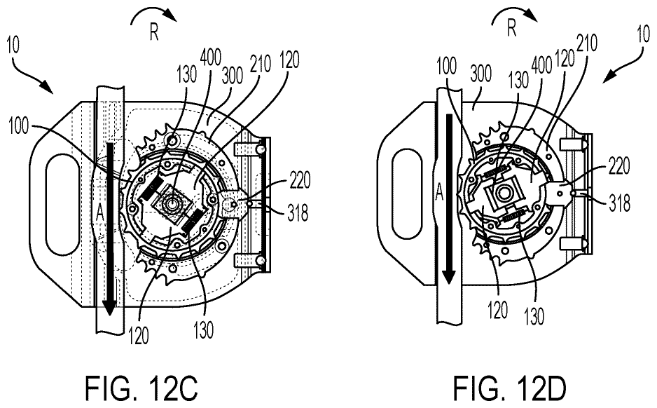

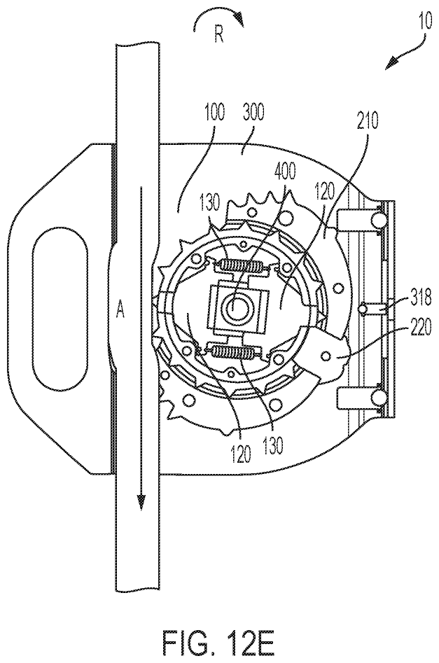

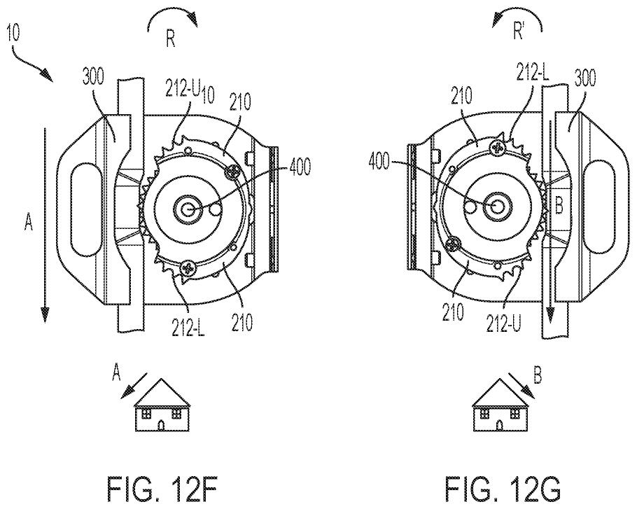

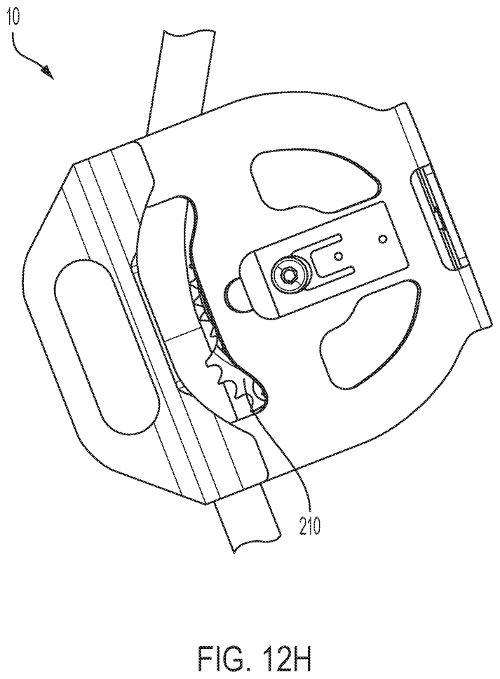

FIGS. 12A and 12B depict the tracking wheel assembly 100 inside of the rocker cam assembly 200. In the example shown, the trip mechanism is trip plate 220 which holds the rocker cam in place by ball detent 318 until the dislodging mechanism dislodges the trip plate 220. There can be a notch on trip plate 220 that fits into the ball detent 318. The trip plate 220 can also be held in place by other means such as magnets, a spring, a pin, or other type of plunger. The trip plate 220 can sit between the rocker cam components 210 or can be attached or a part of the rocker cam components 210. Trip plate 220 can be struck by plates 120 when the plates are extended outside of the tracking wheel assembly 100. This will cause the trip plate 220 to dislodge from the ball detent 318. In one preferred embodiment, the relative dimensions of the trip plate 220 can be 0.58 inches wide, 0.60 inches tall, and 0.09 inches thick.

When the trip plate 220 is dislodged, the rocker cam assembly 200 can rotate/pivot in either direction depending on the direction the tracking wheel is rotating. The rocker cam assembly 200 will rotate or pivot until it is engaging the line and in the engaged position. In one example, there can be a visual indication 222 to inform users of the position of the rocker cam assembly 200 so the user can tell if it is in the locked or engaged position.

Referring to FIGS. 12 C-E, a progression of the climbing device 10 from the locked position to the engaged position is shown. After the line is in a case 300, the line will be in contact with the tracking wheel assembly 100 such that the teeth 112 of the tracking wheel 110 can run along the line as the fall arrest device 10 moves in either direction along the line. As the teeth 112 run along the line, the tracking wheel assembly 100 rotates.

In FIG. 12C, the climbing device 10 is illustrated in use on a line where a climber is descending on the line in the direction of the arrow at a speed not meeting or exceeding the dislodging speed of the device 10 (e.g., 1000 rpm). The tracking wheel assembly 100 rotates in contacting relation along the line as the climber descends. Once the tracking wheel assembly 100 reaches a specific rate of rotation/the device 10 is moving along the line at or above the dislodging speed of the device 10, signaling the climber is in free fall, the centrifugal force of the tracking wheel assembly 100 overcomes the force of the springs 130 that are connected to the plates 120. The springs 130 move from a neutral position to an extended position, thereby allowing the plates 120 to move longitudinally from a first position (as shown in FIG. 7C) to a second position away from each other (as shown in FIG. 12C). In some embodiments, a groove or other similar structure (not shown) can be used in the tracking wheel assembly 100 to hold the plates 120 in longitudinal alignment as the plates 120 move from the first position to the second position. The longitudinal movement of the plates 120 from the first position to the second position, away from the shaft 400, causes the plates 120 to strike the trip plate 220, as shown in FIG. 12D. Once the trip plate 220 is struck by the plates 120, the trip plate 220 makes contact with the ball detent 318 and the ball detent 318 is compressed against a spring (not shown) internal to the ball detent 318. The compression of the spring (not shown) internal to the ball detent 318 releases the rocker cam components 210 from the locked position. The rocker cam components 210 then rotate in the direction of arrow R around the shaft 400 if the device is moving in the position shown by arrow A in FIGS. 12 C-E, and pinch the line with the case 300, arresting the climber's fall, as shown in FIG. 12E. In this embodiment, the rocker cam components 210 rotate around the shaft 400 in the direction of arrow R and pinch the line with the case 300 within 0.01-0.05 seconds.

For example, if a climber was climbing on an A-frame roof, the climber would be able to use the device 10 to arrest his or her fall on either side of the roof. The rocker cam components 210 would rotate around the shaft 400 in the direction of arrow R and the lower rocker cam assembly teeth 212-L would pinch the line with the case 300 if the climber was using the device 10 in the direction of arrow A shown in FIG. 12F. The device 10 will similarly follow the steps described above if it is used in the position shown in FIG. 12G, except the rocker cam components 210 would rotate around the shaft 400 in the direction of arrow R′ and the upper rocker cam assembly teeth 212-U would pinch the line, going in the direction of arrow B, with the case 300, arresting the climber's fall.

FIG. 12H shows the rocker cam components 210 in an engaged position with a line after the device 10 has detected a climber's freefall.

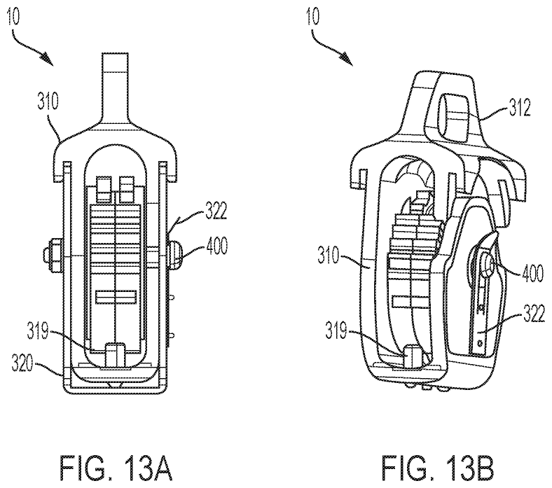

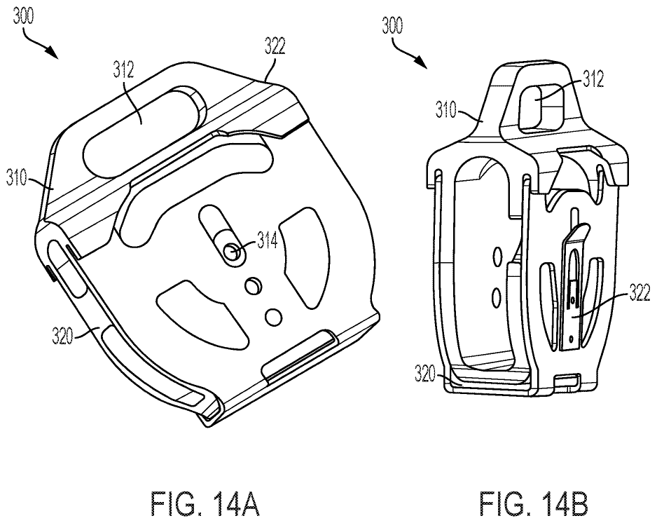

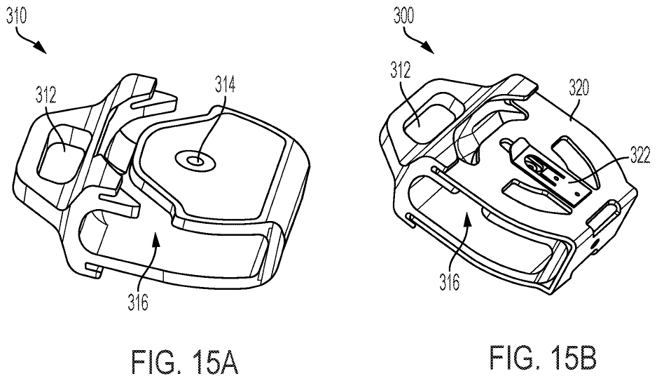

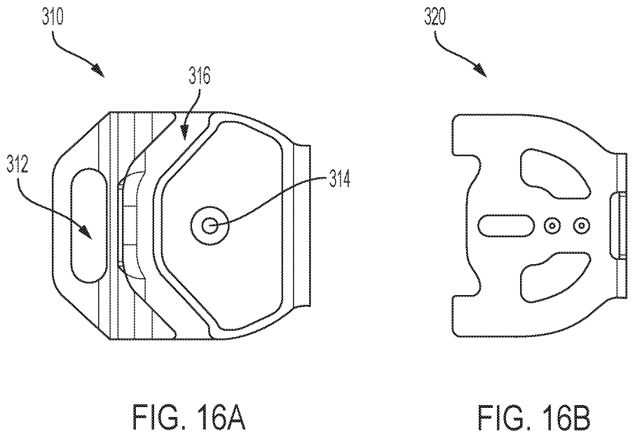

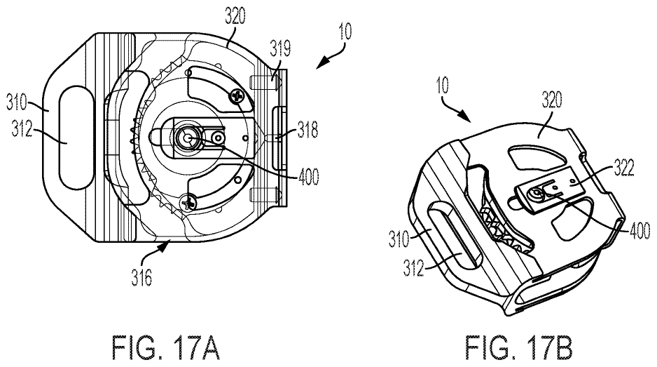

As shown in FIGS. 13A and 13B, the case 300 can house the rocker cam assembly 200 and tracking wheel assembly 100. In one example, the case 300 comprises an inner case 310 and an outer case 320. In another embodiment, there is only an inner case 310. Additionally, in another embodiment, the case 300 and rocker cam assembly 200 can be accomplished with one component or there can be no case at all. Referring now to FIGS. 14-17, the outer case 320 can fit over the inner case 310.

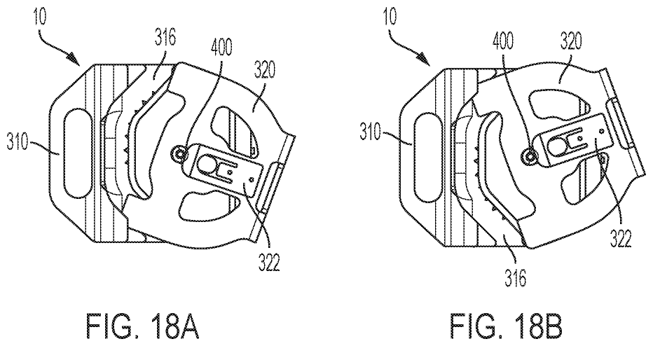

The inner case 310 in one embodiment can comprise the carabiner loop(s) 312, opening 314, line opening 316 (shown more specifically in FIGS. 18A and 18B), ball detent 318, and plunger(s) 319. In one example, the plungers 319 are spring ball plungers. The inner case 310 can have indents or other outer case receiving portions to hold the outer case 320. The outer case 320 in one embodiment comprises the belt clip 322. The belt clip 322 can be a spring belt clip. The shaft 400 can pass through the outer case 320, inner case 310, rocker cam assembly 200, and tracking wheel assembly 100. The outer case 320 can cover portions of or all of the line opening 316 of the inner case 310. There can be an opening in case 300 for the user to be able to view the visual indication 222 (as shown in FIG. 12A) of the rocker cam assembly 200.

Referring now to FIGS. 18A and 18B, the case 300 allows users to attach the fall arrest device 10 at any point along the line. A user can walk up to the line and clip the fall arrest device 10 on to any section of the line instead of needing to find the end of the line and feed it through the device. This saves the user time and hassle. In one example, to attach the fall arrest device 10 to the line, a user can press the inner case 310 and outer case 320 together overcoming the spring plunger's 319 resistance, and simultaneously pull up on the belt clip 322 to bring it over the shaft 400. This will allow the outer case 320 to be rotated around the shaft 400 so that a line can be placed in and out of the line opening 316.

The outer case 320 can be rotated into a first position to allow the user to engage or remove the line halfway into the line opening 316 in the inner case 310. The outer case 320 can be rotated into a second position to allow the user to completely engage or remove the line into or from the line opening 316. Once the line is in the desired position, the outer case 320 can be pushed back into its closed and locked position whereby the belt clip 322 is over the head of the shaft 400 and is drawn back such that it locks in place and the outer case 320 at least partially covers the line opening 316. Case 300 can be attached to the line facing either direction.

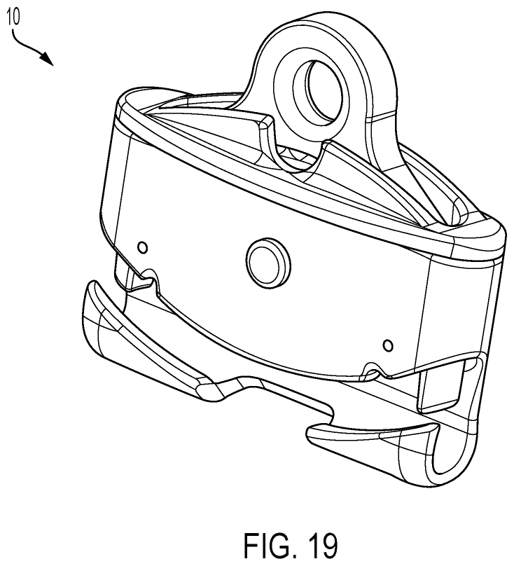

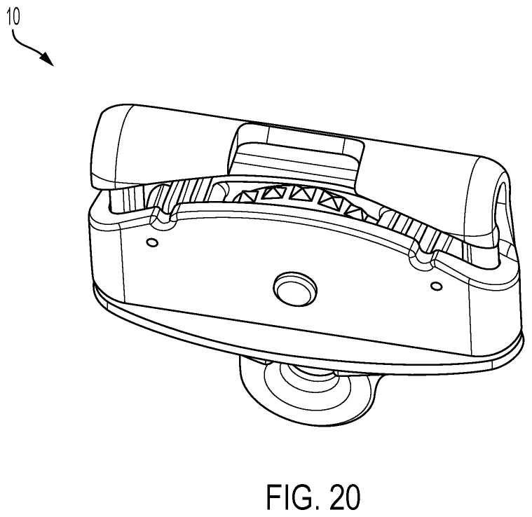

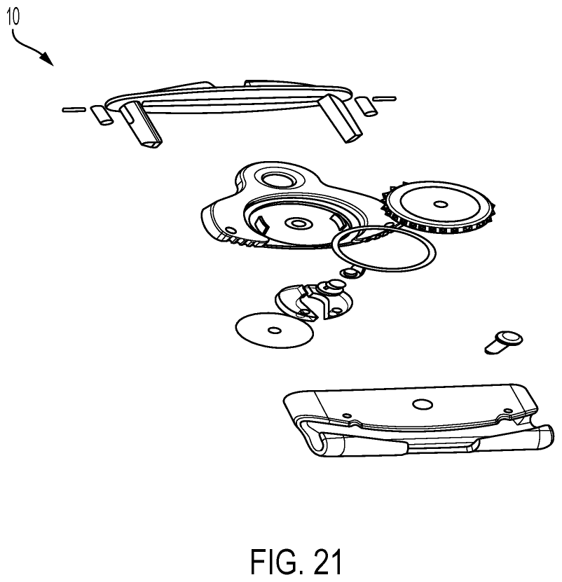

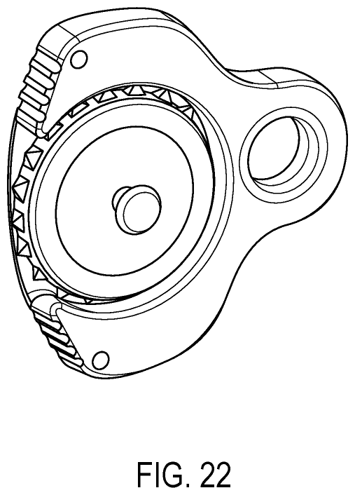

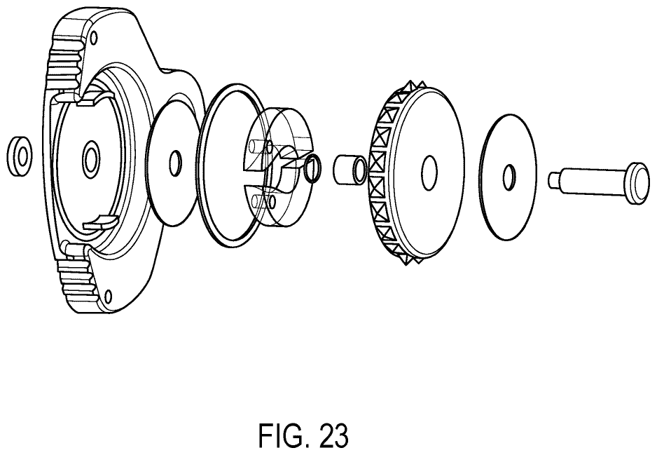

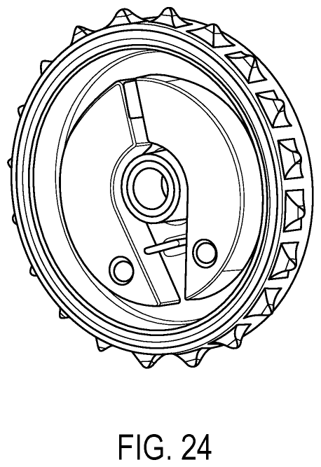

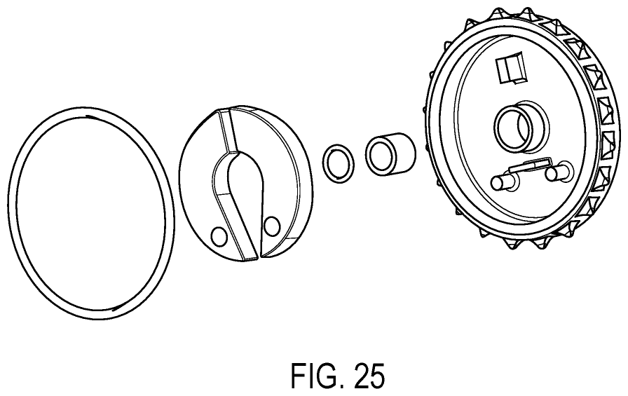

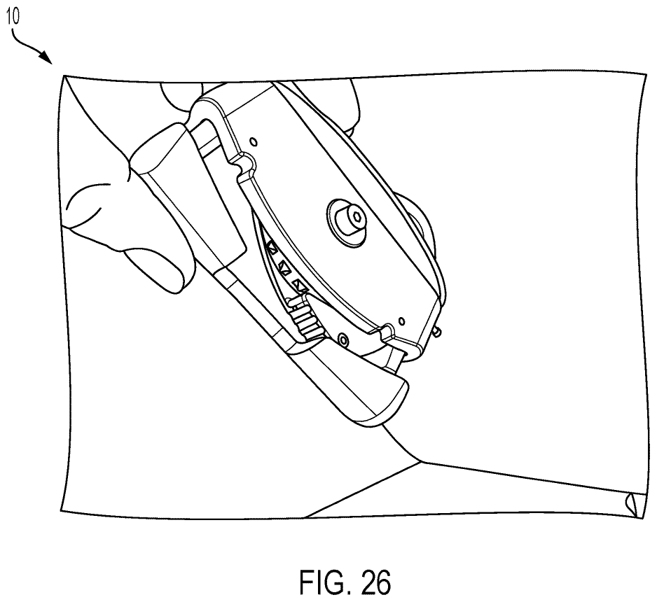

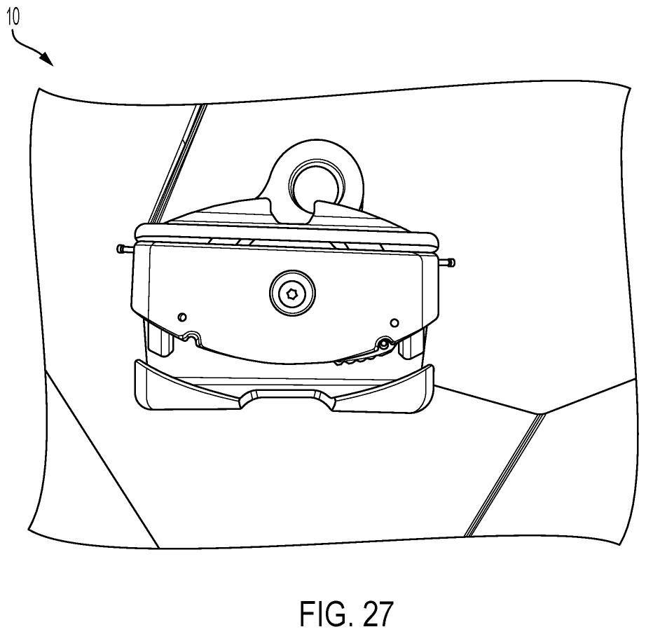

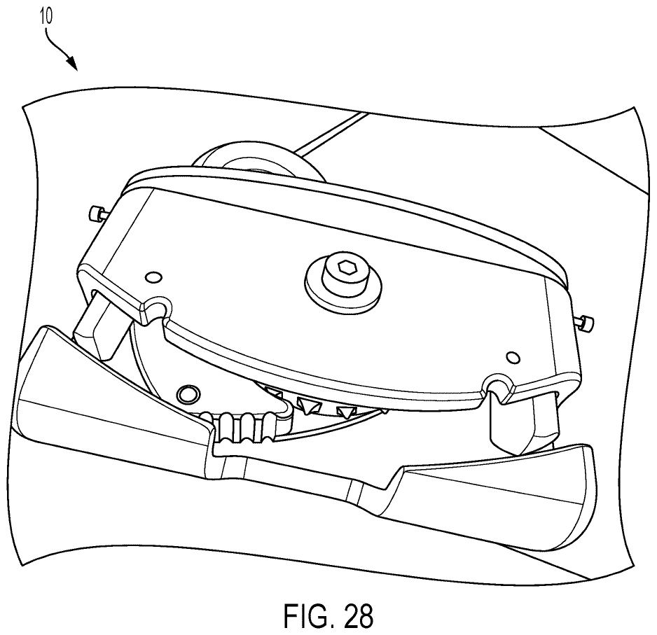

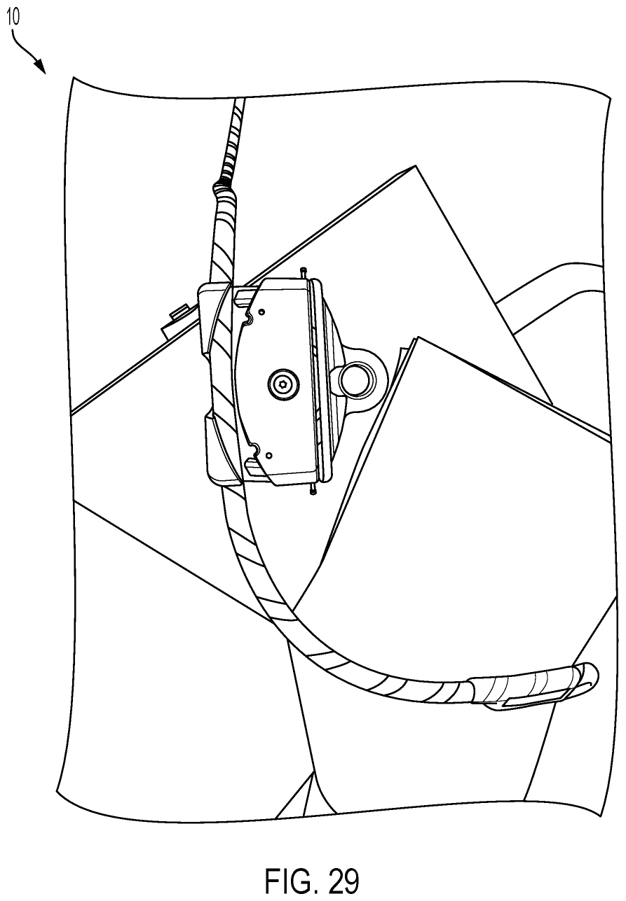

FIGS. 19-29 show alternative embodiments of the fall arrest device 10.

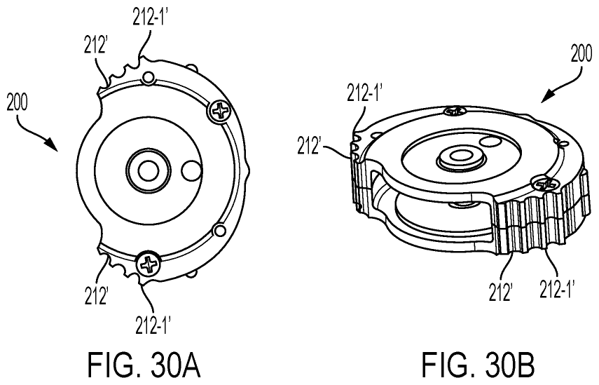

Referring now to FIGS. 30A and 30B, an alternative embodiment of the fall arrest device 10 is shown with updates to features previously referenced above. Rocker cam assembly teeth 212′ are depicted as having blunted line engaging ends 212-1′ instead of line engaging ends that are sharp and come to a point 212-1, as shown above. These blunted or rounded line engaging ends 212-1′ are more appropriate for use with steel cables because the cable is made of a harder material and a sharper end would not grip the cable as easily as it would a rope or webbing. The blunted line engaging ends 212-1′ allow for the fall arrest device 10 to engage and move freely along a steel cable in either direction. Similar to how the device is used with the rocker cam assembly with teeth that have sharp line engaging ends 212-1 depicted above, the fall arrest device 10 with rounded line engaging ends 212-1′ can also be placed on a line and tethered to a climber/user. Additionally, when in the engaged position, the rocker cam assembly teeth 212 with rounded line engaging ends 212-1′ can engage a line formed of a harder material, such as steel cables, and prevent a user from falling by preventing the device 10 from moving along the line any further.

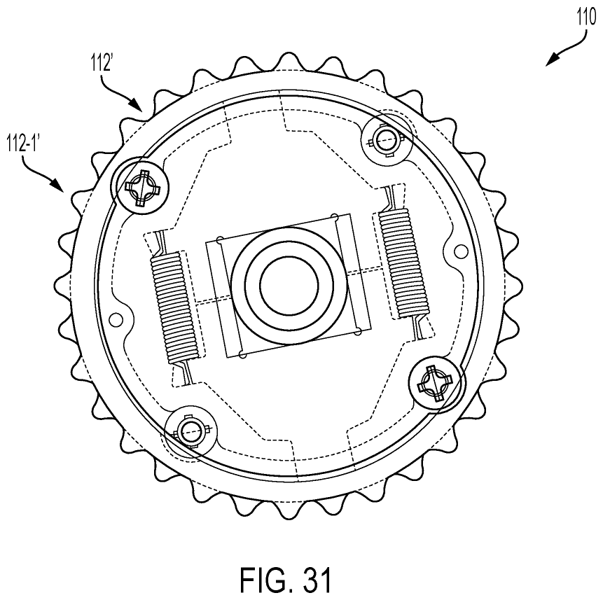

Referring to FIG. 31, in another embodiment, the tracking wheel assembly 100 also features line engaging ends that are blunted or rounded (as opposed to being pointed as shown in other embodiments described above) at the tip 112-1′, such that the teeth 112′ of the tracking wheel 110 can run along a steel cable as the fall arrest device 10 moves in either direction along the steel cable. As stated above, as the teeth 112-1′ run along the line, the tracking wheel assembly 100 rotates.

In another embodiment, the teeth 212 and 112 can be coated in rubber to allow the teeth 212 and 112 to engage with lines of different materials and increase the amount of friction on a metal line.

While a steel cable is described above, a cable of different materials has been contemplated, such as braided cable or fiber for use in climbing wind turbines, ladders, steel poles, towers, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A fall arrest device for attachment to a line, comprising:
a stopping mechanism moveable from a locked position to an engaged position;
a trip mechanism configured to hold the stopping mechanism in the locked position;
a tracking wheel assembly configured to rotate, wherein the tracking wheel assembly is configured to engage with the line and track the movement of the fall arrest device along the line; and
a dislodging mechanism configured to dislodge the trip mechanism when the tracking wheel assembly exceeds a dislodging speed.

2. The fall arrest device of claim 1, wherein the line comprises a rope or a cable.

3. The fall arrest device of claim 1, further comprising a case comprising an inner case and an outer case.

4. The fall arrest device of claim 3, wherein the inner case forms a line opening.

5. The fall arrest device of claim 4, wherein the outer case has a locked position and an unlocked position.

6. The fall arrest device of claim 5, wherein when the outer case is in the unlocked position, the outer case is moveable to uncover at least a portion of the line opening.

7. The fall arrest device of claim 3, wherein the inner case further comprises a plunger between the inner case and the outer case.

8. The fall arrest device of claim 7, wherein the outer case is compressible against the plungers.

9. The fall arrest device of claim 1, wherein the stopping mechanism further comprises a plurality of teeth, each of which includes a line engaging end, wherein each of the line engaging ends is configured to engage with the line when the stopping mechanism is in the engaged position.

10. The fall arrest device of claim 9, wherein the line engaging ends further comprise a pointed line engaging end or a rounded line engaging end.

11. The fall arrest device of claim 1, wherein the tracking wheel assembly further comprises a plurality of teeth, each of which includes a line engaging end, wherein each of the line engaging ends is configured to engage with the line and drive the rotation of the tracking wheel assembly.

12. The fall arrest device of claim 1, wherein the tracking wheel assembly is configured to rotate bi-directionally within the stopping mechanism.

13. The fall arrest device of claim 1, wherein the stopping mechanism can pivot clockwise and counterclockwise.

14. The fall arrest device of claim 1, further comprising a shaft passing through the stopping mechanism and the tracking wheel assembly.

15. The fall arrest device of claim 1, wherein the stopping mechanism is configured for radial movement independent of the tracking wheel assembly.

16. A fall arrest device for attachment to a line, comprising:
a stopping mechanism moveable from a locked position to an engaged position;
a trip mechanism configured to hold the stopping mechanism in the locked position; and
a tracking wheel assembly configured to rotate, wherein the tracking wheel assembly is configured to engage with the line and track movement of the fall arrest device along the line;
a spring having a neutral position and an extended position such that when the tracking wheel assembly rotates at or above a dislodging rate, the spring is in the extended position; and
a plate attached to the spring, the plate having a first position when the spring is in the neutral position and a second position when the spring is in the extended position, further wherein when the plate is in the second position it is configured to dislodge the trip mechanism.

17. The fall arrest device of claim 16, wherein the line comprises a rope or a cable.

18. The fall arrest device of claim 16, wherein the tracking wheel assembly is configured to bi-directionally rotate within the stopping mechanism.

19. The fall arrest device of claim 16, further comprising a case enclosing the stopping mechanism.

20. The fall arrest device of claim 16, wherein the stopping mechanism can pivot clockwise and counterclockwise.

21. The fall arrest device of claim 16, further comprising a shaft passing through the stopping mechanism and the tracking wheel assembly.

22. The fall arrest device of claim 16, wherein the stopping mechanism further comprises a plurality of teeth, each of which includes a line engaging end, wherein each of the line engaging ends is configured to engage with the line when the stopping mechanism is in the engaged position.

23. The fall arrest device of claim 22, wherein each of the plurality of teeth further comprise a pointed line engaging end or a rounded line engaging end.

24. The fall arrest device of claim 16, wherein the tracking wheel assembly further comprises a plurality of teeth, each of which includes a line engaging end, wherein each of the line engaging ends is configured to engage with the line and drive the rotation of the tracking wheel assembly.

25. The fall arrest device of claim 16, wherein the stopping mechanism is configured for radial movement independent of the tracking wheel assembly.
